(19) United States
(12) Patent Application Publication
(10) Pub. No.: US 2026/0363222 A1
(43) Pub. Date: Nov. 19, 2026

(54) METHOD FOR MANUFACTURING A GUIDING ELEMENT FOR A FISHING ROD LINE

(71) Applicant: Loïc CHARUEL, VANNES (FR)

(72) Inventor: Loïc CHARUEL, VANNES (FR)

(21) Appl. No.: 19/133,464

(22) PCT Filed: Dec. 1, 2023
(86) PCT No.: PCT/FR2023/000184

§ 371 Date: May 28, 2025

(30) Foreign Application Priority Data
Dec. 2, 2022 (FR) FR2212710

(51) Int. Cl. A01K 87/04; B29C 70/24; B29L 31/00

(52) U.S. Cl. CPC A01K 87/04; B29C 70/24; B29L 2031/7096

(57) ABSTRACT

A method for manufacturing a guiding element (GEL) for a fishing rod line is provided. The element includes a ring (CRG) rigidly connected to a guide body (GDY) intended to be attached to the rod. The method includes:—a step of coating the ring with a set of reinforcing fibers;—step of shaping the set of reinforcing fibers;—step of covering with a resin the ring coated in this way; and—a step of hardening the guiding element formed in this way. The method does not require machining of material containing carbon fibers or mechanical insertion or gluing of the ring in a hole previously made in the guide body.

The invention relates in general to a method for manufacturing a guiding element for a fishing rod line, the element including a ring rigidly connected to a guide body intended to be fastened to said rod.

### TECHNICAL FIELD

The present invention falls particularly, but not exclusively, into the general field of the manufacture of fishing rods, and more particularly into the field of the manufacture of fishing rods provided with shafts made at least partially using reinforcing fibers.

Such reinforcing fibers may notably be made using carbon, glass, aramid, basalt, or other materials known to a person skilled in the art.

In the prior art, it is common practice to provide the shaft of a fishing rod with a succession of rings intended to guide at least one fishing line extending in a direction parallel to the shaft of the fishing rod, hereinafter referred to as the longitudinal direction, in order to facilitate both casting and reeling in any fish which have bitten the hook.

### PRIOR ART

For many years, fishing rod shafts were made of fiberglass, with the guiding elements being made of metal in order to be glued or bound to the shaft, but these techniques were not satisfactory, firstly because the surface finish of the metal guiding element tended to be abrasive, thereby causing premature wearing of the line, and secondly because friction eventually caused the line, even though it was not very abrasive, to cut through the metal frame, which was not hard enough. In addition, the metal body of the guiding element and the fiberglass body of the fishing rod shaft to which the guiding element was rigidly connected had different deformation and corrosion resistance characteristics, tending to cause premature separation of the guiding element from the fishing rod shaft.

To overcome these drawbacks, a guiding element was devised in the form of an assembly of a ceramic ring within a guide body made using carbon fibers, said guiding element being intended to be fastened to a fishing rod shaft also made of carbon fibers.

Such a method is notably described in document EP3424318B1.

The inventor of the method claimed in the present patent application has however observed that, although the method described in the aforementioned document partially solves the drawbacks of the prior art, implementing this known method raises other problems which remain unsolved.

In fact, the method known from document EP3424318B1 provides for the production, in a first step, of a guide body constructed on the basis of a stack of carbon-fiber sheets pre-impregnated with resin, then cured, thus obtaining a pre-form from which the guide body proper is extracted by machining making it possible both to define the outer perimeter of the guide body, and also to form therein a hole intended to receive a ceramic ring by snap-fitting, the inner annular surface of which must also be covered with an adhesive paste to hold it in position in the hole formed in the guide body.

Such machining is complex and expensive to implement, and more so in the context of mass production of numerous guide rings to be fitted to fishing rods, which are also intended to be mass-produced and delivered.

### PRINCIPLE OF THE INVENTION

The inventor has devised a solution to all the problems described above, and has developed a simple and inexpensive method for the easy and rapid implementation of this solution.

### SUMMARY OF THE INVENTION

The present invention thus proposes a method according to the introductory paragraph, characterized in that it includes:
a step of coating said ring with at least one set of reinforcing fibers;
a step of shaping said set of reinforcing fibers; and
a step of using a resin to cover said ring coated in this way; and
a step of hardening the guiding element formed in this way.

Unlike the method known from the prior art, the method according to the invention does not require the use of a stack of reinforcing-fiber layers, but uses a set of fibers which can be oriented in an optimized manner according to their direction of maximum strength, considered both in tension and in bending.

Moreover, unlike the known method, which includes three successive manufacturing operations, the method according to the invention includes just one and does not require machining of material containing carbon fibers, nor mechanical insertion or gluing of the ring in a hole previously made in the guide body.

This method enables considerable savings in terms of manufacturing time and costs. Indeed, since it does not use any cutting operations, the implementation of this method will not generate wear on cutting tools or material waste resulting from machining, since this is no longer necessary, such waste otherwise requiring expensive recycling treatments. The machining operations provided for in the prior art also usually generate dust that is difficult to trap, and such dust is not generated in the method according to the invention.

Moreover, the guide body is made of a composite material and therefore its outer surface is mainly composed of resin, preferably epoxy resin, which ensures uniform mechanical and physico-chemical behavior with respect to the fishing rod shaft to which it is intended to be secured.

The method according to the invention can be implemented manually, for example by inserting a plastically deformable thread into the set of reinforcing fibers, then by winding this assembly about a ceramic ring and then shaping one end of said assembly which has been left free in order to produce a footing having a shape enabling the guiding element to be secured to the fishing rod shaft for which it is intended. The whole thus shaped can then be covered with a resin to stiffen it, and said resin can be hardened at room temperature or by heating.

The coating step preferably also includes at least one step of gripping the ring by contact with at least one portion of the set of reinforcing fibers arranged about said ring.

The guiding element may be constituted in such a way that the coated ring of the set of reinforcing fibers is directly connected to the footing of the guide body.

In another embodiment of the invention, the guiding element being intended to have at least one leg connecting a fastening zone arranged in the vicinity of an outer circumference of the ring to a footing portion of the guide body, the coating step includes at least one step of gripping the ring by contact with at least one portion of the set of reinforcing fibers arranged about said ring, one end of said portion left free after said gripping being arranged along said leg between the fastening zone and the footing portion.

Alternatively, the guiding element may have at least one leg connecting the ring coated with the set of reinforcing fibers to the footing of the guide body.

According to a particular embodiment of the invention, in which the guiding element is intended to have at least a first leg and a second leg connecting a first fastening zone and a second fastening zone arranged in the vicinity of an outer circumference of the ring (CRG) to at least a single footing of the guide body, the coating step includes at least one step of gripping the ring (CRG) by contact with at least one portion of the set of reinforcing fibers arranged about said ring, one end of said portion left free after said gripping being arranged along at least one of the two legs between the corresponding fastening zone and the footing portion.

This embodiment makes it possible to double the thickness of a leg and thus considerably increase its rigidity. It is preferably applied to each of the two legs in order to optimize overall rigidity. In fact, not only do each of the two legs thus have a double thickness, but the thickness of the reinforcing fibers gripping the ring is also doubled, the entire guiding element thus obtained then having a uniform fiber thickness.

According to an advantageous embodiment of the method described above, the shaping and covering steps include respectively:
a step of inserting the ring coated with the set of reinforcing fibers into a mold having an annular groove connected to at least one effluent groove intended to receive at least one length of fibers in addition to the length used to coat the ring;
a step of filling said mold with a resin.

In addition to the advantages of the invention described above, such an embodiment makes it possible to choose the section of the guide body, beyond the constraints imposed by known technologies.

In this embodiment of the invention, the resin can be left to harden at ambient temperature, but, according to an advantageous embodiment of the method described above, the hardening step will include a step of heating said mold thus filled.

This reduces the manufacturing time of the guiding element according to the invention, and reduces the risk of deformations of said guiding element occurring during the hardening step. In addition, a resin hardened by heating exhibits more efficient behavior in terms of mechanical strength.

According to a variant of the invention described above, the additional length of fibers extends beyond the effluent groove until it rests in a rectilinear groove intended to form the footing of the guide body, this rectilinear groove extending the effluent groove and being substantially perpendicular to a plane containing the circular groove.

According to a particular variant of the invention described above, the rectilinear groove is intended to receive a removable cylinder coated in at least one hollow portion with a set of reinforcing fibers before the filling step.

Such a variant creates a cylindrical sheath rigidly connected to the guide ring that is capable of receiving the end of the rod, which enables the perfect and highly robust positioning of the “head” ring, which is intended to withstand the intense forces generated when casting or by a flailing fish, despite being fastened to the thinnest end of the fishing rod.

According to a variant of this preferred embodiment of the invention, the method described above includes a step of inserting one end of the set of reinforcing fibers left free after the ring has been coated into a hollow portion of said set intended to be placed in the vicinity of the fastening zone.

This variant makes it possible to double the thickness of the hollow portion in which the end of the set of reinforcing fibers is inserted, thereby making it considerably more robust.

According to a preferred embodiment of the invention, said set of reinforcing fibers intended to coat the ring includes a hollow braid.

This embodiment produces a bead completely enveloping the periphery of the ring, thereby optimally consolidating the connection between the ring and the guide body. In addition, the fact that the braid is hollow makes it relatively easy to insert other fibers therein longitudinally, thereby further increasing the rigidity of the guiding element.

Moreover, according to one of its material aspects, the invention also relates to a guiding element for a fishing rod line obtained by implementing a method as described above.

Moreover, according to another of its material aspects, the invention also relates to a mold for implementing a method according to the description above.

### BRIEF DESCRIPTION OF THE DRAWINGS

Other features and advantages of the invention will become more clearly apparent on reading the following description of a particular embodiment, given by way of illustrative and non-limiting example, and with reference to the attached figures:

FIG. 1 is a perspective view illustrating a guiding element for a fishing rod line obtained by implementing the invention;

FIG. 2 is a perspective view illustrating a manufacturing step of such a guiding element;

FIG. 3 is a perspective view illustrating a detail of the manufacturing step shown in the preceding figure;

FIG. 4 is a schematic view illustrating a cross-section of a guiding element according to a preferred embodiment of the invention;

FIG. 5 is a schematic view illustrating a coating step according to a particular embodiment of the invention;

FIG. 6 is another schematic view illustrating a coating step according to a particular embodiment of the invention;

FIG. 7 is a perspective view illustrating an advantageous embodiment of a guiding element according to the invention;

FIG. 8 is another perspective view illustrating a half-mold intended to be assembled with a complementary half-mold to implement a method according to the invention; and

FIG. 9 is a perspective view illustrating an element for guiding a fishing rod line obtained by implementing a variant of the invention.

### DESCRIPTION OF THE EMBODIMENTS

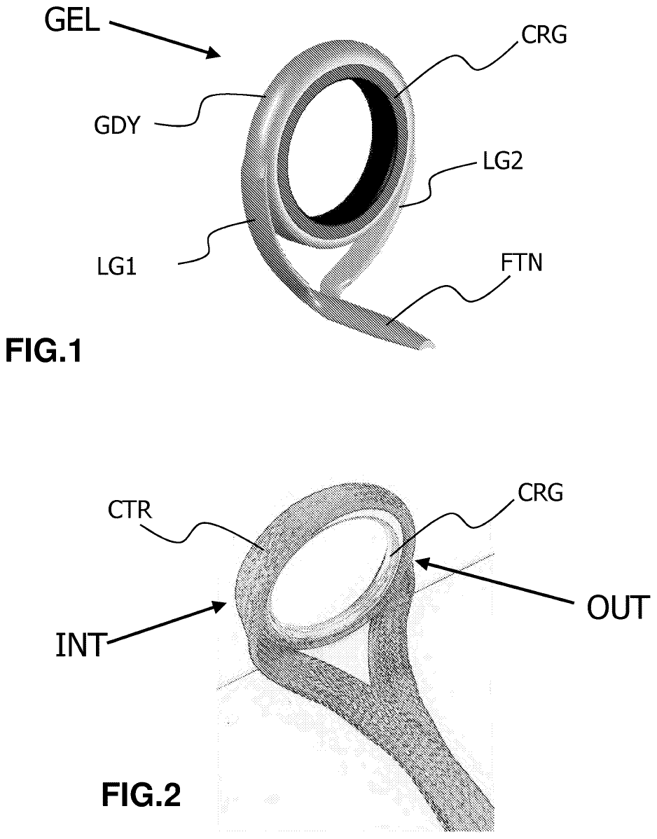

FIG. 1 shows a guiding element GEL for a fishing rod line including a ring CRG, for example made of ceramic material, rigidly connected to a guide body GDY intended to be fastened to said rod by means of a footing FTN connected to the guide body via first and second legs (LG1, LG2).

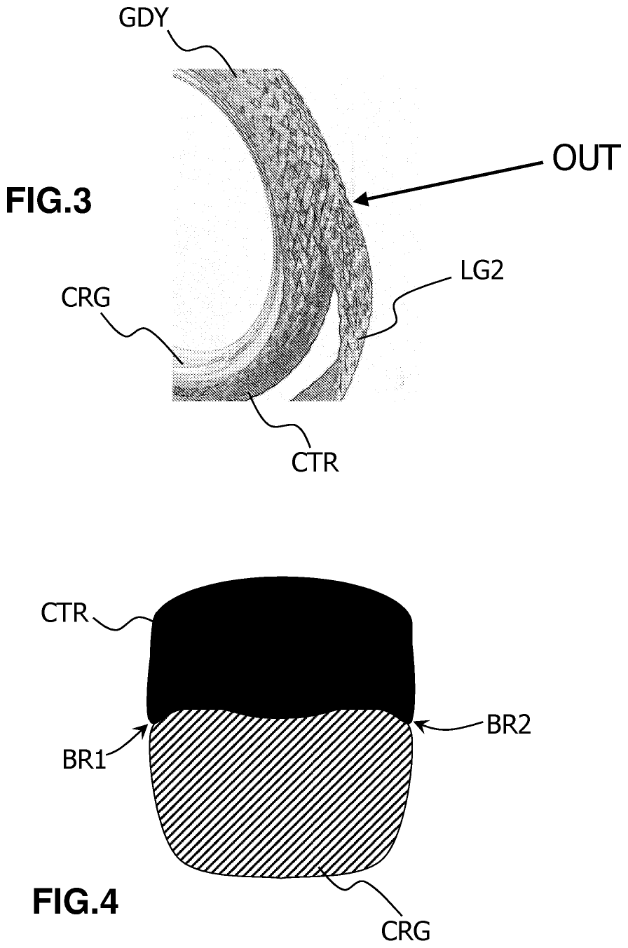

FIGS. 2 and 3 illustrate a manufacturing step for the guiding element shown in the previous figure, which includes:
a step of coating said ring CRG with at least one braid of reinforcing fibers CTR;
a step of shaping said braid of reinforcing fibers ctr.

As illustrated by these figures, the ring CRG is gripped by contact with the braid of reinforcing fibers CTR arranged about said ring, i.e. the ring CRG is not separated from said braid of reinforcing fibers CTR by a layer of resin, said resin being intended to be applied to the assembly formed by the ring CRG coated by gripping with the braid CTR.

According to the preferred embodiment of the invention shown here, said braid of reinforcing fibers CTR coating the ring CRG is a hollow braid.

This embodiment forms a bead (BR1, BR2) completely enveloping the periphery of the ring CRG, thereby optimally consolidating the connection between the ring CRG and the guide body, as shown in FIG. 4, which is a partial cross-section in a plane perpendicular to the plane of the ring.

This manufacturing step is intended to be followed by the following steps, not shown here:
a step of using a resin to cover said ring CRG coated in this way; and
a step of hardening the guiding element formed in this way.

Unlike the method known from the prior art, the method according to the invention does not require the use of a stack of reinforcing-fiber layers, but uses a set of reinforcing fibers, formed here by the braid of fibers CTR, which can be oriented in an optimized manner according to their direction of maximum strength, considered both in tension and in bending.

In the manufacturing method described here, an end LG2 of the braid CRT left free after coating the ring CRG is inserted into a portion of the hollow body of said fiber CTR at the point indicated by the arrow INT and extracted from the hollow body of said fiber CTR at the point indicated by the arrow OUT.

In other embodiments not shown here, the braid of reinforcing fibers CTR need not be hollow, but one end of the braid left free after coating the ring CRG can be passed through said braid to enable a gripping of the ring similar to the gripping obtained with the insertion technique described in the preceding paragraph, in the manner of a slip knot.

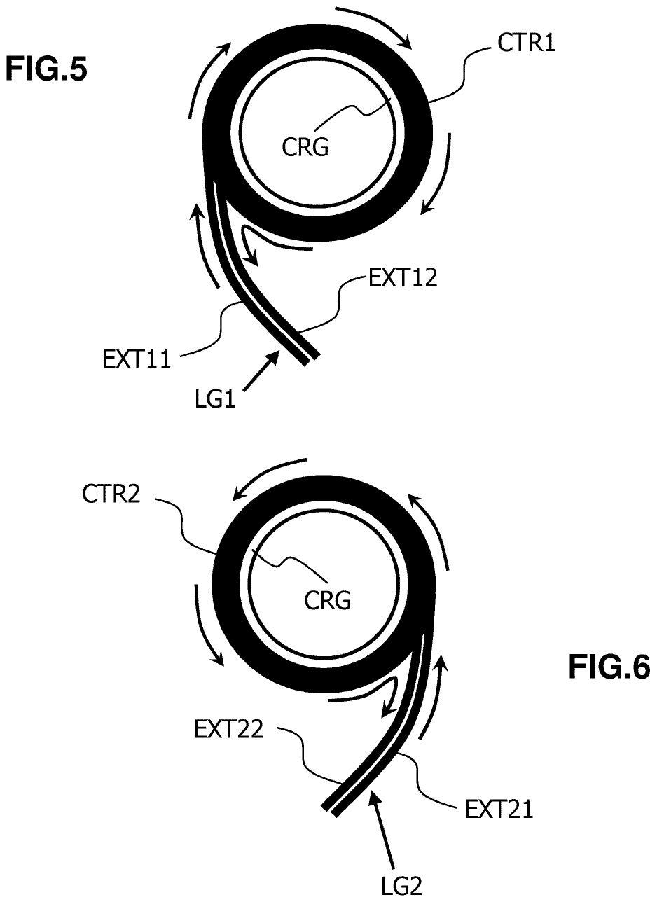

FIG. 5 is a schematic view of a coating step which includes at least one step of gripping the ring CRG with at least a portion of the set of reinforcing fibers, which is in this case carried out in the clockwise direction. In this example, a first free end EXT11 of a first set of reinforcing fibers CTR1 and a second end EXT12 left free after said encircling are arranged substantially parallel beside each other so as to be secured together during the covering step in order to form the first leg LG1.

In the preferred embodiment of the invention in which the set of reinforcing fibers CTR1 is a hollow braid, the second end EXT12 can be inserted into the first end EXT11 where the two ends meet in the vicinity of the ring CRG, thus forming a first fastening zone.

This embodiment makes it possible to double the thickness of the first leg LG1 and thus considerably increase its rigidity.

FIG. 6 is a schematic view of a coating step similar to the preceding figure which includes at least one step of gripping the ring CRG with at least a portion of the set of reinforcing fibers, which is in this case carried out in the anticlockwise direction. In this example, a first free end EXT21 of a second set of reinforcing fibers CTR2 and a second end EXT22 left free after said encircling are arranged substantially parallel beside each other so as to be secured together during the covering step in order to form the second leg LG2.

In the preferred embodiment of the invention in which the set of reinforcing fibers CTR2 is a hollow braid, the second end EXT22 can be inserted into the first end EXT21 where the two ends meet in the vicinity of the ring CRG, thus forming a second fastening zone.

The combined implementation of the two coating steps described in FIGS. 5 and 6 makes it possible to double the thickness of the first and second legs LG1 and LG2, and consequently also the thickness of the footing FTN, and thus to considerably increase the rigidity of all these elements.

Furthermore, not only do each of the two legs LG1 and LG2 thus have a double thickness, but the thickness of the reinforcing fibers gripping the ring CRG is also doubled, the entire guiding element thus obtained then having a uniform fiber thickness.

Such a combined implementation of the two coating steps described in FIGS. 5 and 6 can be carried out by winding a second set of reinforcing fibers having the ends EXT21 and EXT22, as shown in FIG. 6, about a first set of reinforcing fibers having the ends EXT11 and EXT12, as shown in FIG. 5. In such an embodiment, the ring CRG is gripped with the second set of reinforcing fibers CTR2 by contact with the first set of reinforcing fibers CTR1, and not by direct contact with the ring CRG itself. Thus, the ring CRG is not separated from the first set of reinforcing fibers CTR1 by a layer of resin, and neither are the first and second sets of reinforcing fibers CTR1 and CTR2, which are in direct contact with each other, the resin being intended to be applied to the assembly formed by the ring CRG coated by gripping with the two sets of reinforcing fibers CTR1 and CTR2.

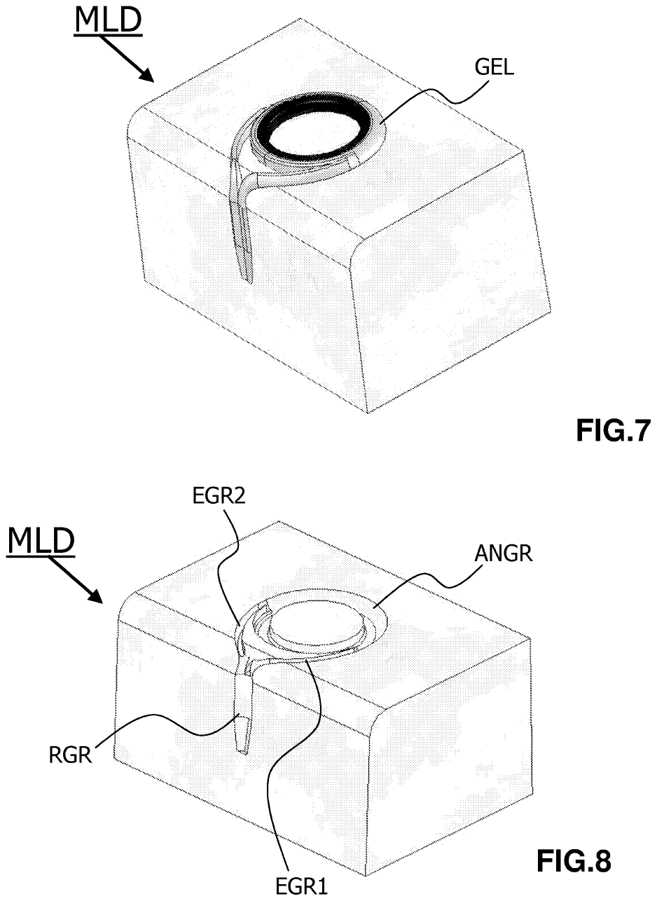

FIGS. 7 and 8, which are to be considered together, show an advantageous embodiment of the method described above, in which the shaping and covering steps include respectively:
a step of inserting the ring coated with the braid of reinforcing fibers into a mold MLD having an annular groove ANGR connected to at least one effluent groove (EGR1, EGR2) intended to receive at least one length of braid in addition to the length used to coat the ring;
a step of filling said mold MLD with a resin.

In the embodiment of the mold MLD, of which only one half is shown here, the effluent grooves (EGR1, EGR2) lead to a rectilinear groove RGR intended to form the footing of the guide body, said rectilinear groove RGR being substantially perpendicular to a plane containing the circular groove.

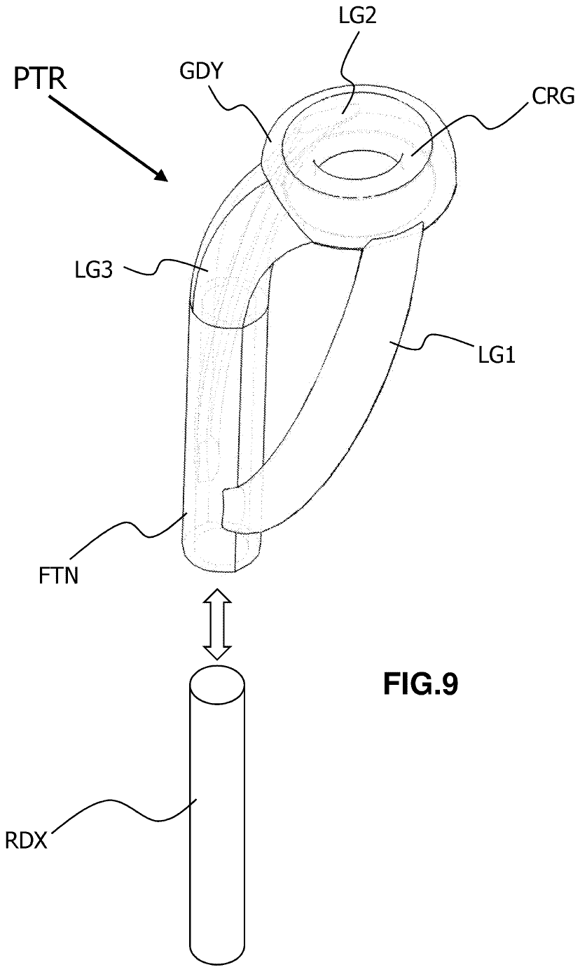

FIG. 9 shows a guiding element PTR obtained using a mold in which the rectilinear groove has a cylindrical section intended to receive a removable cylinder coated in at least one portion of braid of reinforcing fibers before the filling step. In addition, the mold used to produce the guiding element PTR shown here contains first, second and third effluent grooves intended to form first, second and third legs (LG1, LG2 and LG3), the third leg LG3 occupying a central position and extending the footing FTN of the guiding element PTR.

Such a variant creates a cylindrical sheath rigidly connected to the guide ring CRG and that is capable of receiving one end RDX of the fishing rod, which enables the perfect and highly robust positioning of the “head” ring CRG, which is intended to withstand the intense forces generated when casting or by a flailing fish, despite being fastened to the thinnest end of the fishing rod.

1. A method for manufacturing a guiding element (GEL) for a fishing rod line, the element including a ring (CRG) rigidly connected to a guide body (GDY) intended to be fastened to said rod, wherein the method includes:
a step of coating said ring (CRG) with a set of reinforcing fibers (CTR);
a step of shaping said set of reinforcing fibers (CTR);
a step of using a resin to cover said ring (CRG) coated in this way; and
a step of hardening the guiding element formed in this way.

2. The method as claimed in claim 1, wherein the coating step includes at least one step of gripping the ring (CRG) by contact with at least one portion of the set of reinforcing fibers arranged about said ring.

3. The method as claimed in claim 1, wherein the shaping and covering steps include respectively:
a step of inserting the ring (CRG) coated with the set of reinforcing fibers (CTR) into a mold (MLD) having an annular groove (ANGR) connected to at least one effluent groove (EGR1, EGR2) intended to receive at least one length of fibers in addition to the length used to coat the ring (CRG); and
a step of filling said mold (MLD) with a resin.

4. The method as claimed in claim 3, wherein the hardening step includes a step of heating said mold (MLD) thus filled.

5. The method as claimed in claim 1, wherein said additional length of fibers extends beyond the effluent groove until it rests in a rectilinear groove (RGR) intended to form the footing of the guide body, this rectilinear groove extending the effluent groove (EGR1, EGR2) and being substantially perpendicular to a plane containing the circular groove (ANGR).

6. The method as claimed in claim 5, wherein said rectilinear groove (RGR) is intended to receive a removable cylinder coated in at least one hollow portion with a set of reinforcing fibers before the filling step.

7. The method as claimed in claim 1, wherein the guiding element being intended to have at least one leg connecting a fastening zone arranged in the vicinity of an outer circumference of the ring (CRG) to a footing portion of the guide body, the coating step includes at least one step of gripping the ring (CRG) by contact with at least one portion of the set of reinforcing fibers arranged about said ring, one end of said portion left free after said gripping being arranged along said leg between the fastening zone and the footing portion.

8. The method as claimed in claim 1, wherein the guiding element being intended to have at least a first leg and a second leg connecting a first fastening zone and a second fastening zone arranged in the vicinity of an outer circumference of the ring (CRG) to a single footing portion of the guide body, the coating step includes at least one step of gripping the ring (CRG) by contact with at least one portion of the set of reinforcing fibers arranged about said ring, one end of said portion left free after said gripping being arranged along at least one of the two legs between the corresponding fastening zone and the footing portion.

9. The method as claimed in claim 7, wherein the method further it includes a step of inserting one end of the set of reinforcing fibers left free after the ring has been coated into a hollow portion of said set intended to be placed in the vicinity of the fastening zone.

10. The method as claimed in claim 1, wherein said set of reinforcing fibers (CTR) includes a hollow braid.

11. A guiding element (GEL) for a fishing rod line obtained by implementing a method as claimed in claim 1.
